(19) United States
(12) Patent Application Publication
(10) Pub. No.: US 2016/0100622 A1
(43) Pub. Date: Apr. 14, 2016

(54) Food Product Mold and Method for Installing Same

(71) Applicant: Weidenmiller Company, Itasca, IL (US)

(72) Inventors: RICH PAUL BUDEK, Elmhurst, IL (US); STEPHEN J. KRAS, Chicago, IL (US)

(21) Appl. No.: 14/850,839

(22) Filed: Sep. 10, 2015

Related U.S. Application Data
(60) Provisional application No. 62/062,853, filed on Oct. 11, 2014.

(51) Int. Cl. A23P 1/10; B23P 11/02

(52) U.S. Cl. CPC A23P 1/105; B23P 11/027

(57) ABSTRACT

We disclose a mold for forming a food product is disclosed. The mold includes a pocket that is capable of receiving an insert. The pocket is circumscribed by a lip. The pocket includes an interference interference structure that interacts with a peripheral wall of an insert. An insert may be a block, a block assembled with a cap, or a block assembled with an electronic device. The insert includes or is adapted to include a mold cavity for receiving and forming the food product. We also disclose a method for installing a food product mold into a mold tool. An insert is inserted into a pocket arranged on a surface of a tool and a compression fit retains the insert in the pocket. After cooling the insert, the insert is installed in the pocket. As the insert warms, it expands to fill the pocket creating a compression fit.

### RELATED APPLICATIONS

The present patent document claims the benefit of the filing date under 35 U.S.C. §119(e) of Provisional U.S. Patent Application Ser. No. 62/062,853, filed Oct. 11, 2014, which is hereby incorporated by reference in its entirety, including all drawings and documents filed therewith.

### BACKGROUND

Consumers increasingly rely upon the convenience of packaged food products. Convenience foods for both animals and humans have proliferated—and range from healthy to indulgent. Consumables such as but not limited to cookies, candies, crackers, and animal nourishment, come in a variety of textures, compositions, shapes, and sizes. Rotary die cutters and rotary die molds are a popular method of forming consumable food products.

### BRIEF SUMMARY

A mold for forming a food product is disclosed. The mold includes a pocket that is capable of receiving an insert. The pocket is circumscribed by a lip. The pocket includes an interference structure on its inner surface. The interference structure interacts with a peripheral wall of an insert. An insert may be a block, a block assembled with a cap, or a block assembled with an electronic device. The insert includes or is adapted to include a mold cavity for receiving and forming the food product.

A method for installing a food product mold into a mold tool is also disclose. An insert is inserted into a pocket arranged on a surface of a tool and a compression fit retains the insert in the pocket. The insert is cooled prior to installing the insert in the pocket. After cooling the insert, the insert is installed in the pocket. As the insert warms, it expands to fill the pocket creating a compression fit.

Other features and advantages of the disclosure will be, or will become, apparent to one of skill in the art upon examination of the following figures and detailed description. It is intended that all such additional advantages and features be included in the description, be within the scope of the invention, and be protected by the claims.

### BRIEF DESCRIPTION OF THE DRAWINGS

FIG. 1 provides an exemplary rotary tool with surface food product molds;

FIG. 2 provides an exemplary pocket isolated from the tool and a block;

FIG. 3 provides a cross section of the pocket of FIG. 2;

FIG. 4 provides an example of a block sized larger than a pocket and installed into a pocket with a compression fit;

FIG. 5 provides an example of a block positioned within a pocket after the block is reduced and includes a perspective of a cutting device;

FIG. 6 provides an example in cross section of a mold cavity machined into a block;

FIG. 7A provides an exemplary mold cavity applied to a block retained within a pocket;

FIG. 7B provides a magnified view of an exemplary mold cavity applied to a block retained within a pocket and positioned beneath a lip;

FIG. 8A provides an alternative exemplary mold cavity applied to a block retained within a pocket;

FIG. 8B provides a magnified view of the exemplary mold cavity of FIG. 8A;

FIG. 8C provides a partial cross section view of the pocket with the block removed;

FIG. 9A provides a cross section of a first variation of a cap assembled with a block;

FIG. 9B provides a cross section of a second variation of a cap assembled with a block;

FIG. 10 provides a portion of a tool including pockets;

FIG. 11A provides a cross section of a cavity insert with a cap of the first variation fit and retained in a pocket;

FIG. 11B provides a cross section of a cavity insert with a cap of the second variation fit and retained in a pocket;

FIG. 12 provides a mold cavity machined through the cap portion of a cavity insert and into the block portion of the cavity insert;

FIG. 13 provides a partial view of a tool with mold cavities filled with a dough;

FIG. 14A provides a cavity insert of FIG. 13 removed from the pocket;

FIG. 14B provides the block of FIG. 14A removed from the cap portion;

FIG. 14C provides the remaining cap portion of FIG. 14A and FIG. 14B in cross section removed from the block;

FIG. 15 provides a plate mold having removable mold cavities;

FIG. 16 provides a cross section of FIG. 15;

FIG. 17 provides a magnified view in cross section of a pocket showing an exemplary interference structure;

FIG. 18 provides a magnified view in cross section of a pocket assembled with a mold insert;

FIG. 19 provides an exemplary view of a tool with an electronic device insert;

FIG. 20 A provides an exemplary electronic device assembled with a block;

FIG. 20B provides a second exemplary electronic device assembled with a block;

FIG. 21A provides a block assembled with an electronic device and further assembled with a pocket prior to the reduction of size of the block;

FIG. 21B provides the block of FIG. 7A assembled with an electronic device;

FIG. 21C provides the block of FIG. 8A assembled with an electronic device; and

FIG. 22 provides an electronic device installed in a surface of a food product mold tool.

### DETAILED DESCRIPTION OF THE DRAWINGS

Food products of various kinds, including cookies, crackers, candies, animal consumables, and other products, are frequently formed by high-volume automated rotary mold and/or rotary cutting devices. A rotary die is a cylinder, the surface of which is covered with shallow engraved cavities. A rotary cutter is a cylinder, the surface of which is covered with portions that rise about the face of the cylinder. Hybrid forms may also exist which include both engraved cavities and raised portions. In one exemplary process, a rotary die cylinder rotates past the opening in a hopper filled with food product (e.g., a food dough). The food product fills any engraved portions on the cylinder. Excess dough is sheared off from the main mass by a blade. As the cylinder continues to rotate, the dough pieces are ejected onto a conveyor belt.

In another exemplary process, rotary die cutting uses a cylindrical die on a rotary press. A long sheet or web of material is fed through the rotary press into an area which holds a rotary tool, for example but not limited to, a rotary die cutter or a rotary die mold. The rotary tool may cut out shapes, make perforations or creases, impart aesthetic design, and/or cut the sheet or web into smaller parts. Rotary die cutting allows for the manufacture of multiple substantially identical formed products.

Food manufacturing technologies have struggled with the challenge of food product release. Several processes are used to release the formed product from the rotary tool. Some add fat and lard to the dough recipe to act as lubricants and discourage attachment of the food product to the rotary tool. With the rising popularity of fat-free products, the industry increasingly adopted rotary tool coatings to assist release of formed shapes. Moreover, the addition of fats and oils is not practical for all food types. Some food products, such as candy, are tacky and cling to forming surfaces. Examples of rotary tool coatings include formulations of PTFE, TEFLON, metals and ceramics that are FDA and USDA approved for food contact.

While coatings may be effective for releasing product from tooling, they have several drawbacks. Many known coatings, including but not limited to PTFE and formulations of PTFE, wear out quickly from repeated use; therefore the rotary tools require routine maintenance. As the rotary tool coatings wear out, the release fidelity decreases. Product increasingly sticks to the surface of the rotary tool.

Decreases in fidelity result in considerable expense due to lost food product (e.g., through deformations, and sticking), down time, and loss of efficiency. Furthermore, the maintenance process results in downtime. Maintenance requires removing the subject machine from operation while the rotary tool is removed for repair and reconditioning of, e.g., the tooling surfaces. The reconditioning process takes several days to several weeks and bears a significant expense. The expense is related to both the cost of repair and reconditioning and the interruption in production leading to reduced product and therefore reduced profits. In an attempt to realize a large product output despite the maintenance inefficiencies, many companies are required to run several machine lines so that they can rotate production and maintenance. This requires larger more expensive facilities to house redundant machinery.

One solution for improving product release from tooling is the use of cavity inserts. In a variation, a die cylinder is manufactured with cavities. Inserts bearing a desired food product design are assembled with the cavities. The inserts are often plastic inserts, such as but not limited to, acetal inserts. The use of cavity inserts has improved product release and has lengthened maintenance intervals. However, inserting and maintaining the inserts in the cavities continues to be a challenge.

The Conventional Method. The conventional construction of a die roll tool involves inserting plastic blocks, e.g., acetal plastic blocks, into cavities machined into the surface of a die roll tool. The cavity may have a variation of geometries. The geometries may be defined by the geometry of the ultimate food product, or by other principals such as efficiencies or special limitations. (In an example, an oval cavity may be used for an oval food product. In another example, a square geometry cavity may be used for an insert that results in a round geometry food item.)

Cavity inserts are assembled with the cavities. It has been found that press-fitting a cavity insert into a cavity is not sufficient to retain the cavity insert in the cavity during manufacturing. To secure the cavity insert, many employ adhesives, such as epoxy. In one example, a groove is cut into the sidewall of the die roll pocket. A corresponding mating groove is cut into the cavity insert. The cavity pocket and the cavity insert-mating groove are filled with adhesive and the cavity pocket and the cavity insert are assembled together. The adhesive cures to hold the cavity insert into the cavity pocket.

Often during manufacturing processes employing cavity inserts, the cured adhesive fractures under manufacturing stress. Retention of the cavity insert in the cavity is compromised by the fractured epoxy. When retention of the cavity insert into the cavity is compromised, several occurrences are observed. In one example, the compromised cavity inserts spin around the central axis, e.g., during the production molding process. This may cause a loss of product fidelity, a loss of consistent design application, and/or malfunction. In another example, the compromised cavity and/or cavity insert may promote leakage of dough into the seam, crevice or space between the cavity and the cavity insert. Similarly, dough leakage may cause loss of product fidelity, loss of product consistency, product design defects, malfunction, and/or contamination.

In another example, pressure developed in a dough molding process can cause dough to be forced into this space resulting in force acting on the cavity insert. Forces acting on the cavity insert can deform the cavity insert, for example, deforming the sidewalls. The forces acting on the cavity insert may also force the cavity insert out of the pocket of the die roll. Deformations, movement, and loss of the cavity inserts, among others, require repair and result in, among other things, production downtime and maintenance expense.

### DEFINITIONS

Definitions: unless stated to the contrary, for the purpose of the present disclosure the following terms shall have the following definitions:

A reference to “another variation” in describing an example does not imply that the referenced variation is mutually exclusive with another variation unless expressly specified.

The terms “a,” “an” and “the” mean “one or more,” unless expressly specified otherwise.

The phrase “at least one of” when modifying a plurality of things (such as an enumerate list of things) means any combination of one or more of those things, unless expressly specified otherwise.

The term “represent” and like terms are not exclusive, unless expressly specified otherwise. For example, the term “represents” does not mean “represents only,” unless expressly specified.

The term “e.g.” and like terms means “for example, but not limited to” and thus does not limit the term or phrase it explains.

Novel Method of Cavity Block Retention. We disclose a method and device that improves the retention of cavity inserts in die roll cavities. Our method and device significantly increase maintenance intervals as compared to conventional cavity insert technology. Our novel technology, method, and device also leads to better wear, increased product fidelity, increased product consistency, decreased production costs and increased profits due to, among other factors, a reduction in down time.

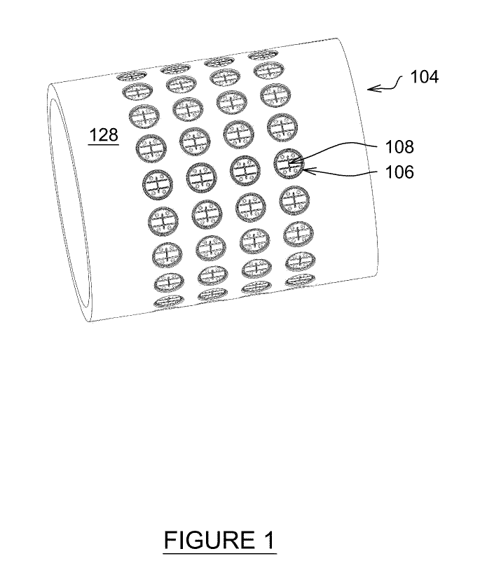

Turning to FIG. 1, we show an insert system. The insert system may include at least a rotary tool 104, pocket 106, and an insert. The insert may have several variations. In FIG. 1, the insert is a block 108. (Further herein, we disclose that the insert may also be a block assembled with a cap and a block assembled with an electronic device, among others.) The rotary tool has a tool outer surface 128. A pocket 106 may be inscribed into a rotary tool 104, e.g., by machining, milling or similar methods.

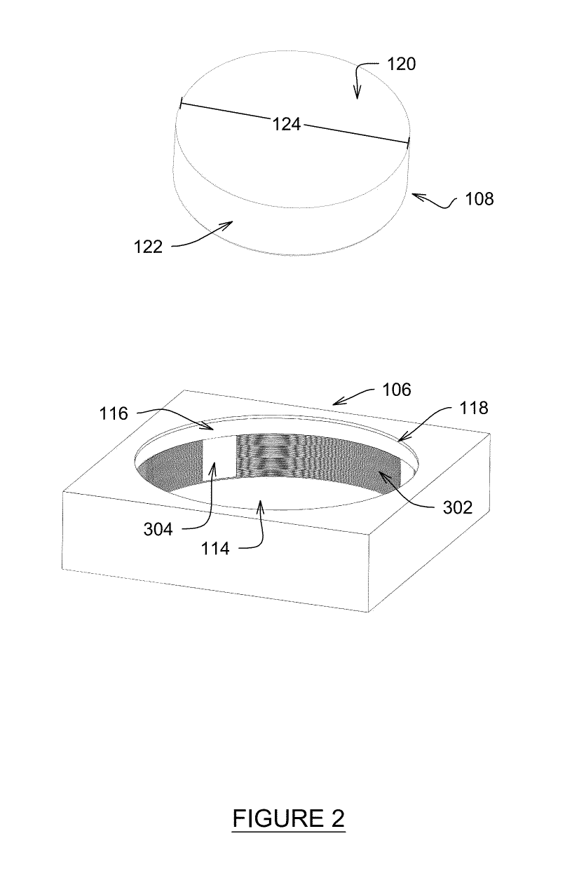

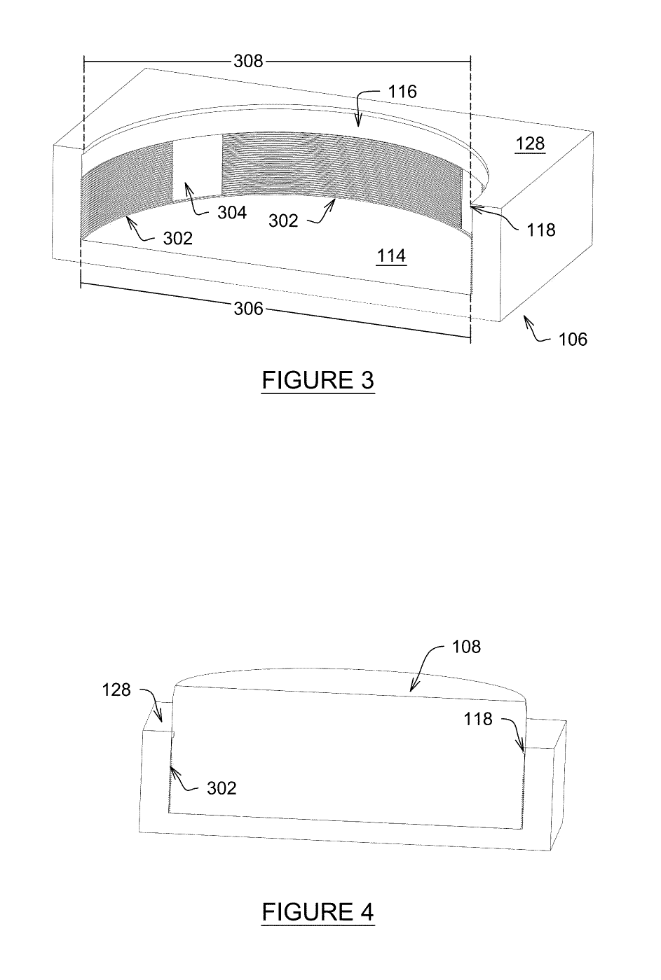

FIG. 2 shows an isolated exemplary pocket 106. For ease of discussion, the pocket 106 is illustrated separate from the entire rotary tool 104. While the pocket 106 is illustrated in circular geometry, it should be understood that the pocket 106 may have any desired geometry. The pocket 106 may have an inner surface, which may include a bottom wall 114 and a pocket sidewall 116. (In some variations, due to the geometry of the pocket, the side wall and/or bottom wall portions of the inner surface may not have sharp delineation.) The pocket 106 may also include an opening circumscribed by a lip 118. The block 108 may be constructed of plastic, such as but not limited to, acetal plastic. The block 108 may have a block top surface 120 and a perimeter 122. The block 108 may have a size that is larger than the size of the pocket 106. For example, the block may have a block diameter 124. The block diameter 124 may be larger than a pocket diameter FIG. 3, 306 or lip diameter FIG. 3, 308. The block 108 may have any desired geometry, although circular is shown for illustration.

FIG. 3 illustrates a cross section magnified view of a pocket 106. FIG. 3 introduces a magnified view of the lip 118 an interference structure 302, which may be serrations machined into an inner surface of the pocket, such as a pocket sidewall 116. The pocket 106 has a pocket diameter 306, which is the diameter of a region of the pocket 106 measured from the pocket sidewall 116. The pocket 106 also has a lip diameter 308, which is a diameter circumscribed by the lip 118.

In this variation, the interference structure 302 is illustrated as a set of horizontal serrations. In a variation, the serrations of the interference structure 302 may be, for example but not limited to, approximately 0.001 inch to approximately 0.015 inch (or any value in between) from tip of serration to surface of a pocket sidewall 116. It should be understood that the serrations may be vertical or diagonal and fall within the scope of the definition. The interference structure 302 may refer to any set of structures machined into the inner surface of the pocket 106, e.g., pocket sidewall 116.

The interference structure 302 may be located around the inner surface of the pocket 106. The interference structure 302 may be continuous around the inner surface of the pocket 106 or may be discontinuous. For example, the interference structure 302 may include interruption sections 304. The interruption sections 304 may represent locations on the inner surface of the pocket, e.g., the pocket sidewall 116, which lack serrations. Alternatively or additionally, the interruption sections 304 may represent locations on the pocket sidewall 116, at which the serration pattern changes. The interruption sections 304 may inhibit rotation of the block 108 within the pocket 106, providing an interruption fit.

The interference structure 302 may retain the block 108 within the pocket 106. The interference structure 302 may be capable of retaining the block 108 within the pocket 106 with an interruption fit that does not require the use of adhesives. Removing the reliance on adhesives may decrease maintenance needs due to a decrease in incidence of block 108 deformations, loosening of blocks 108 and other retention problems as discussed herein. The reduction of adhesives may also reduce the opportunities for chemical contaminants to enter the dough loaded into the cavities.

While the interference force between the block 108 and the interference structures 302 associated with the pocket sidewall 116 is large immediately after insertion, over time the block 108 may relax. For example, if the block 108 is a plastic block, creep of the block 108 material may lead to a reduction of the interference force. The interference structures 302 may remain embedded in the block 108, even as the block material experiences relaxation and/or creep. The interference structures 302 may retain the block 108 in the pocket 106 up to indefinitely.

In a scenario, relaxation of the block 108 material may modify the block 108 structure such that it is capable of rotating within the pocket 106. To prevent rotation of the block 108 within the pocket 106, sidewall serrations may be interrupted or removed at one or more locations, (introduced above as interruption sections 304). The discontinuity of the interference structure 302 may create increased interference between the block 108 and the pocket 106 such that rotation is reduced or prevented. It should be recognized that while discontinuity is advantageous, it is not critical. Even without introducing the discontinuity, the novel arrangement of the pocket 106 and the block 108 provides superior performance over the conventional methods of retaining the block 108 in the pocket 106 with adhesive.

In a variation, the block 108 may be sized larger than the pocket 106, for example, the pocket diameter 306 may be smaller than the block diameter 124, e.g., the block diameter 124 in the pre-cooled state of the block 108 (see FIG. 2). (The pre-cooled state of the block is the state and size of the block prior to cooling, e.g., treatment with liquid nitrogen.) Additionally or alternatively, the block 108 may be sized larger than the opening of the lip 118. For example, the lip diameter 308 may be smaller than the block diameter 124, e.g., smaller than the block diameter 124 in the pre-cooled condition. The block 108 may also be sized larger that then lip such that, after insertion and swelling, the block 108 is larger than the opening of the lip 118 and retained beneath the lip 118. Additionally or alternatively, the lip diameter 308 may be smaller than the pocket diameter 306. In an example, the pocket diameter 306 may be, e.g., approximately 0.020 inch to approximately 0.050 inches smaller than the block diameter 124.

In a variation in which the pocket diameter 306 is smaller than the block diameter 124, the relative difference in diameter may produce a retaining force upon the block 108, creating a compression fit (e.g., a fit created by the swelling of the block 108 after insertion in a pocket 106). For example, the block 108 in its pre-inserted state may have a block diameter 124 that is larger than the pocket diameter 306. When the block 108 is inserted into the pocket 106, e.g., by the method disclosed herein, the compressing force of the pocket 106 on the block 108 may serve to retain the block 108 in the pocket 106. Furthermore, the size differential between the block 108 and the pocket 106 may cause the interference structure 302 to bite into the perimeter 122 of the block 108. The biting of the interference structure 302 into the perimeter 122 of the block 108 may apply an additional or alternative retaining force. The size differential between the block 108 and the pocket 106 may also account for a tighter seal, which may have several advantages discussed herein, such as inhibiting the entry of contaminants in the crevice between the block 108 and the pocket 106.

The method of inserting the block 108 into the pocket 106 may include the following steps. The steps may be performed in a different order and all of the steps do not need to be performed.

(1) providing a tool, which may be a rotary tool or a plate mold tool (described further herein);

(2) machining a pocket 106 into the surface of the tool;

(3) machining an interference structure 302 into the inner surface of the pocket 106;

(4) providing a lip 118 with a lip diameter 308; the lip diameter 308 smaller than the pocket diameter 306;

(5) providing a block 108; the block 108 having a size larger than at least one of the pocket 106 and/or the opening of the lip 118;

(6) cooling the block 108, e.g, by treating the block with liquid nitrogen to create a liquid nitrogen treated block (e.g., a block which has decreased in size due to liquid nitrogen treatment);

(7) inserting the block 108, which may be a liquid nitrogen treated block, into the pocket 106;

(8) allowing the block 108 to obtain a temperature, e.g., room temperature, the temperature of the rotary tool or otherwise; (which will cause the block 108 to increase in size, See FIG. 4, which illustrates what the block 108 may look like after insertion into the pocket 106 and swelling back toward an original size)

(9) reducing the block 108 by running a cutting surface over the surface of the rotary tool; e.g., resulting in a block top surface 120 that is continuous with the surface of the rotary tool; and

(10) machining a mold cavity (FIG. 6, 600) into the block 108; the mold cavity 600 machined to a depth below the surface of the rotary tool representing, e.g., the desired depth of the product to be molded; the mold cavity 600 alternatively or additionally having a desired shape, thickness, and imprinted design.

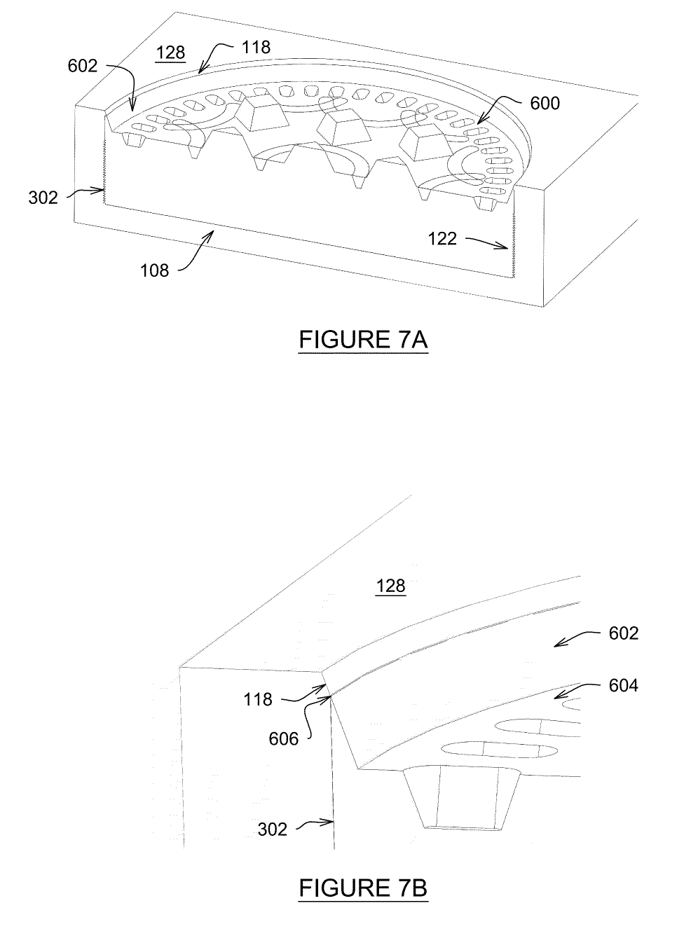

FIGS. 7A-7B illustrate an exemplary end result (in cross section) of the method described above. A block 108 is retained within a pocket 106 by a compression force, creating a compression fit. Where an interference structure 302 is utilized, the compression fit may further cause the interference structure 302 to bite into the perimeter 122 of the block 108.

The block 108 includes a mold cavity 600. The mold cavity 600 has mold cavity sidewalls FIG. 6, 602 and a mold cavity floor FIG. 6, 604. The mold cavity 600 includes an imprinted design. A lip diameter 308 is smaller than the diameter of the block 108, (here, smaller than the diameter of the block in its inserted form). In a variation, the lip 118 forms a continuous surface with the sidewalls of the mold cavity 600.

In FIG. 6, a cut away view of a block 108 assembled with a pocket 106. A mold cavity 600 has been machined into the block 108. A top edge surface 606 of the block 108 is retained below a lip 118 circumscribing the pocket 106. In standard operation of a rotary tool 104, dough is forced into the molding cavities 600. The dough is thereby molded into the desired shape and thickness and/or imprinted with a desired design. Excess dough is trimmed by a cutting device, e.g., by a trim knife, scraper, or other cutting blade arrangement. Repeated passage of the cutting device 502 across the tool outer surface 128 and further (in conventional systems) across the junction where the die roll surface meets the block 108, may cause wear to the tool outer surface 128.

It has been observed that, in conventional systems not employing the novel lip 118 disclosed and claimed herein, the repeated passage of the cutting device 502 across the rotary tool outer surface 128 causes wear to the top edge of the block 108. In some instances, the passage of the cutting device 502 across the tool outer surface 128 may force or move an edge of the block 108 out of contact with the pocket sidewall 116. During wear, a space may open between the block 108 and the pocket 120. The space may allow food product to enter forcing a distortion and wear on the block 108.

We disclose herein a novel and effective method of reducing wear by providing a lip 118, which may be continuous with the tool outer surface 128. The lip 118 may sit above and retain a top edge surface 606 of the block 108 below the tool outer surface 128. The lip 118 may be a ring of the die roll surface material (e.g., brass) and may extend over a top edge surface 606 of the block 108, when the block 108 is assembled in the pocket 106. The lip 118 may prevent contact between the cutting device 502 and a top edge surface 606 of the block 108. This may decrease wear, thereby extending the life of the block 108, e.g., by eliminating the pulling away of the block 108 from the sidewalls of the pocket 106 and the incumbent warping and wear to the block 108 that occurs when a space or gap is opened.

We disclose herein a novel method to achieve resizing a block 108, for example but not limited to a plastic block, or an acetal plastic block, such that it will overcome the obstructions to fitting and retaining into a pocket 106. The method includes immersing the block 108 in liquid nitrogen. We found that, as the temperature of the block 108 is reduced during heat transfer from the block 108 to the liquid nitrogen, the size of the block 108 is reduced, and further, a diameter of the block 108 is reduced. When the block 108 is immersed in liquid nitrogen, the heat transfer from the block may be rapid and the outside dimensions (e.g., a diameter and/or shape), may be reduced to a dimension smaller than, for example but not limited to, the pocket diameter 306, and/or the lip diameter 308. The block 108, after treatment with liquid nitrogen, may be inserted into the pocket 106. The block 108, after treatment with liquid nitrogen, may be assembled with the pocket 106 with or without the application of force. The liquid nitrogen treatment of the block 108 may reversibly reduce the interference between the block 108 and the pocket 106.

The block 108, after liquid nitrogen treatment, may be inserted into the pocket 106 and may warm, e.g., to room temperature and/or to the temperature of the rotary tool, as heat is transferred into the block 108, e.g., from the ambient atmosphere and/or from the rotary tool. The block 108 may expand during the temperature transition, thus increasing the size of the block to create a compression fit securing the block 108 into the pocket 106. The force of the expansion of the block 108 may be substantial and may be sufficient to deform the block 108, e.g., where the interference structure 302 contact the block 108. The interference structure 302 of the pocket 106 may embed into the block 108. The block 108 may expand to create a contact and seal with the pocket 106, e.g., a seal with the perimeter of the pocket 106, including but not limited to, the pocket sidewall 116, the bottom wall 114 and/or the interference structure 302. While this example does not include using mating surfaces on the block 108, mating surfaces are a possible variation.

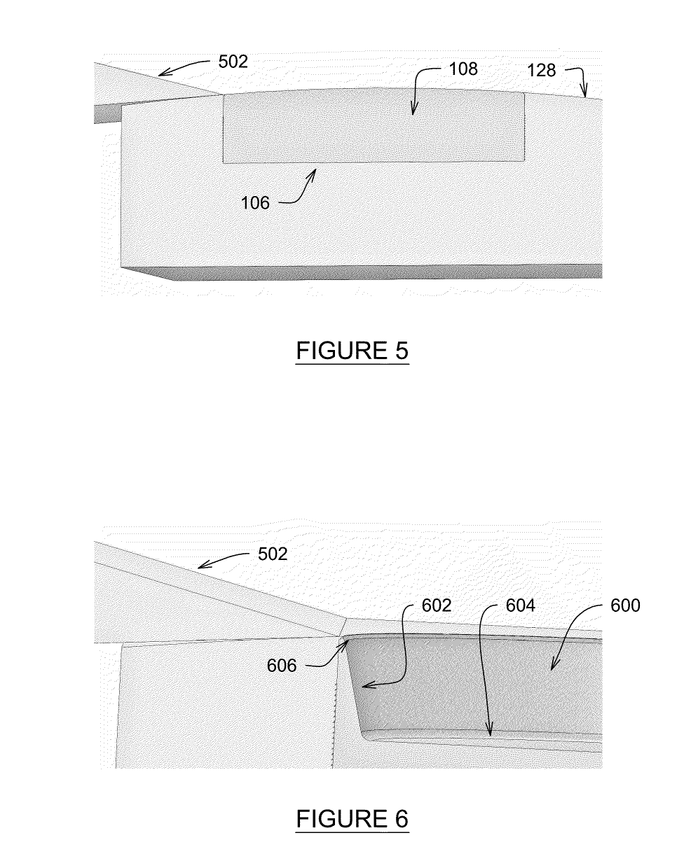

As seen in FIG. 4, when the block 108 is initially fit into the pocket 106, a portion of the block 108 may emerge above the pocket 106. The block 108 may be reduced such that the block top surface 120 is continuous with the tool outer surface 128. The block 108 may be reduced by a cutting device 502. A generic representation of a cutting device 502 is shown in FIG. 5 for illustrative purposes.

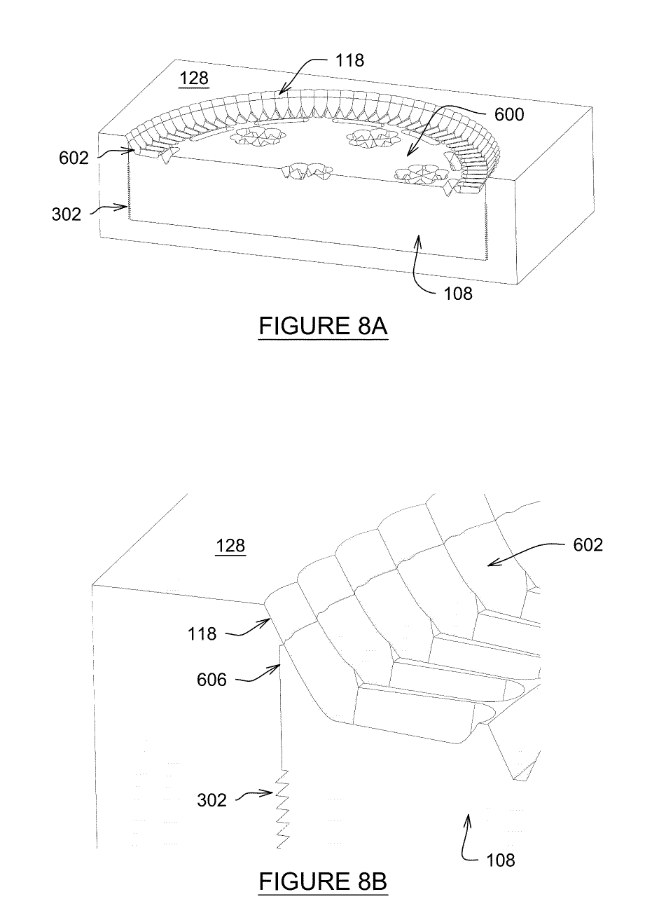

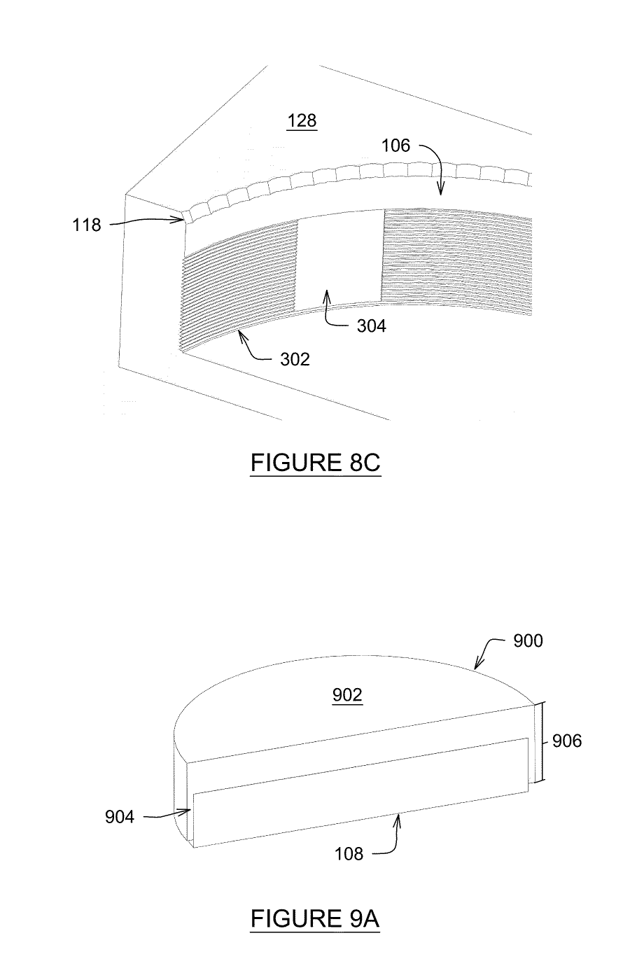

FIGS. 8A-8C demonstrate a variation in which the lip 118 is imparted with a design. In this example, the design is continuous with and carries seamlessly onto the mold cavity sidewalls 602. FIG. 8B is a magnified view of a region of the block 108 assembled with a pocket 106. A top edge surface 606 of the block 108 is retained below a lip 118 circumscribing the pocket 106. FIG. 8C illustrates the pocket 106 with the block 108 removed.

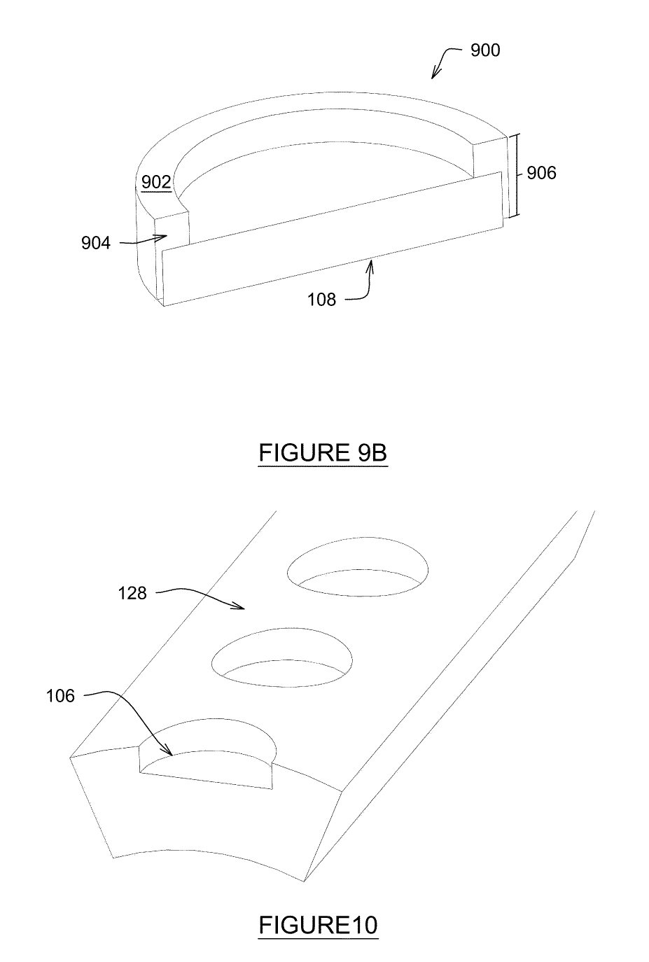

FIGS. 9-14 illustrate a variation on the method of assembling a block 108 with a pocket 106 circumscribed by a lip 118. As discussed above, using conventional methods, it is difficult to insert a block 108 into the pocket 106 of a rotary tool 104 and achieve a tight fit. Conventional methods use adhesives to retain the block 108 in the pocket. No conventional methods use a method of sizing the block 108 larger than the pocket 106 and then reducing the size of the block 108 with liquid nitrogen prior to removal. The method disclosed and claimed herein may negate the need to use adhesives. The conventional methods also have a second problem. Once the block 108 is inserted into the pocket 106, a crevice may remain at the junction between the block 108 and the pocket 106. Additionally or alternatively, in convention methods, a crevice may be created at the junction between the block 108 and the pocket 106. This crevice may be created, e.g., by wear as the cutting device 502 contacts an outer peripheral surface of the block 108, e.g., where the top edge surface 606 is coincident with the tool outer surface 128. In the conventional configuration, the cutting device 502 may pull an outer peripheral surface of the block 108 away from the pocket sidewall 116. The crevice may permit dough to enter and degrade tool performance, creating a tooling fault and ultimately product defects.

We introduce herein novel method of avoiding such defects including introducing a lip 118 for extending over and guarding the junction between the block 108 and the pocket 106, to reduce the possibility of a crevice forming. Since the lip 118 represents a further reduction in the diameter of the pocket 106, it should be understood that conventional methods of applying the block 108 to the pocket 106, e.g., sizing the block a fraction larger than the diameter of the pocket 106 and pressing the block 108 into the pocket 106 using force, would be made more difficult with the addition of a lip 118. We provide a second method of introducing a lip 118 to a cavity and installing a block 108 into the pocket 106 beneath the lip.

In the variation of FIG. 9A, the cavity insert includes a block 108 and a cap 900. The cap 900 may be made of any conventional material known in the manufacturing of rotary tools, e.g., brass. The cap 900 may have a cap top surface 902 and cap sidewalls 904 descending down from the cap top surface 902. A block 108 may be fit and retained into the cap 900 by pre-treating the block 108 with liquid nitrogen. A block 108 may also be fit and retained in the cap 900 by a press fit or other method. The block 108 may be fit and retained in the cap 900 such that it abuts the underside of the cap 900, and there is surface-to-surface contact between an inner diameter of the cap 900 and the outer diameter of the block 108. In FIG. 9A, the cap top surface 902 is shown as a continuous surface which completely covers the block 108 when viewed from the top. The cap top surface 902 may be discontinuous. An example is provided at FIG. 9B.

In the variation of FIG. 9B, the cavity insert includes a block 108 and a cap 900. The cap 900 may be made of any conventional material known in the manufacturing of rotary tools, e.g., brass. The cap 900 may have a cap top surface 902 and cap sidewalls 904 descending down from the cap top surface 902. A block 108 may be fit and retained into the cap 900 by pre-treating the block 108 with liquid nitrogen. A block 108 may also be fit and retained in the cap 900 by a press fit or other method. The block 108 may be fit and retained in the cap 900 such that it abuts the underside of the cap 900, and there is surface-to-surface contact between an inner diameter of the cap 900 and the outer diameter of the block 108. In FIG. 9B, the cap top surface 902 has a hollow therein. The cap top surface 902 thus forms a ringed cap surface above the block 108. The block 108 is thus viewable through the cap 900 when viewed from above. The size, depth and extension of the hollow may vary depending upon the application.

FIG. 10 provides a portion of a rotary tool 104 including pockets 106. The pockets 106 may or may not include interference structure FIG. 3, 302 and/or interruption sections 304. The cavity insert including the cap 900 and the block 108 may be inserted into the pocket 106. The cavity insert may be inserted by press fit methods. However, the fit of the cavity insert (including the cap 900 and the block 108) may also be accomplished by pretreating the cap 900 and/or the block 108 with liquid nitrogen. The discussion of the method of treating an insert with liquid nitrogen (above) is hereby incorporated in this section in its entirety.

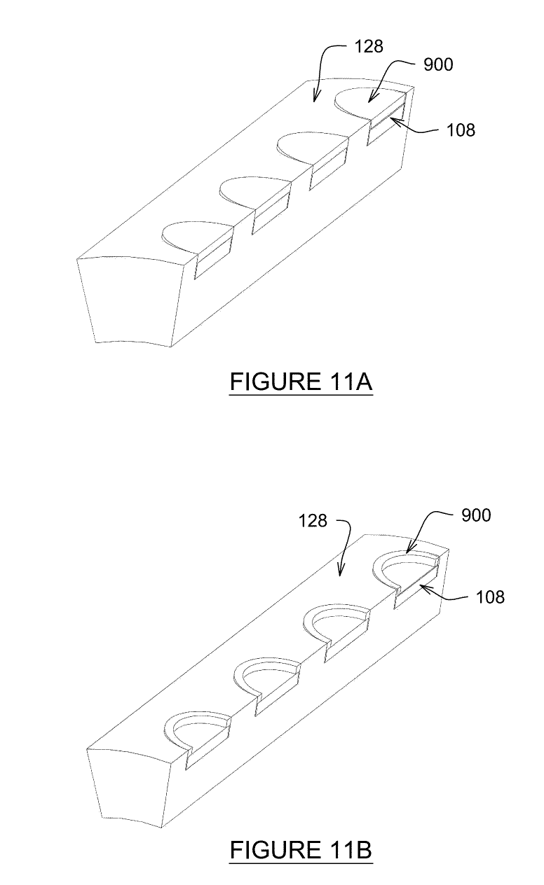

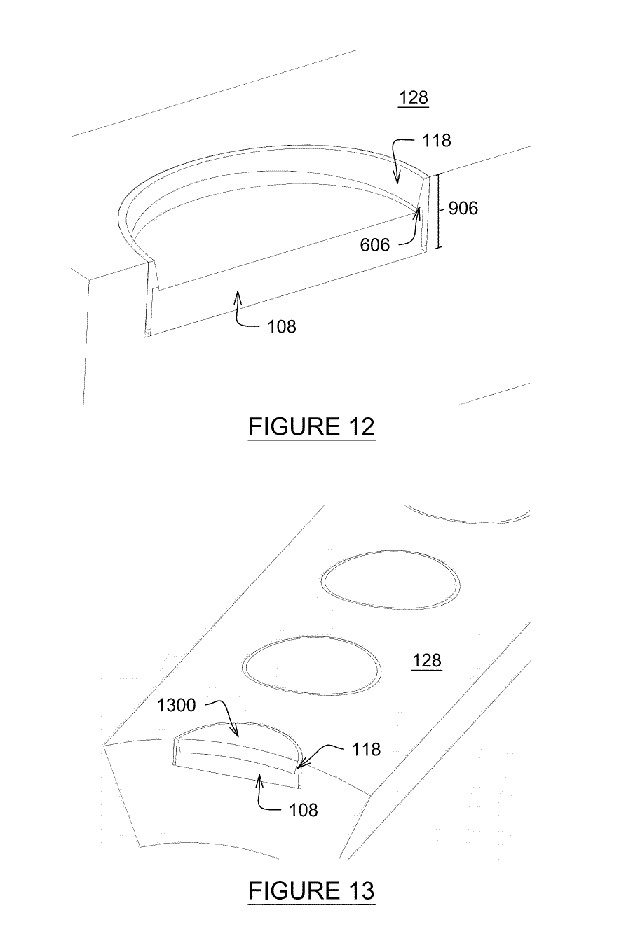

FIG. 11A shows the cavity insert (including the cap 900 assembled with the block 108) fit and retained into a pocket 106. The cap 900 has a height (FIG. 9A, 906) sufficient to extend above and below the tool outer surface 128. With this as a starting material, to result in FIG. 12, the cap 900 may be machined to make it continuous with the tool outer surface 128. A mold cavity 600 may be machined through the cap top surface 902.

FIG. 11B shows the cavity insert (including the cap 900 of FIG. 9B assembled with the block 108) fit and retained into a pocket 106. The cap 900 has a height (FIG. 9B, 906) sufficient to extend above and below the tool outer surface 128. The cavity insert may go through further processing as described herein.

FIG. 12 shows the mold cavity 600 is machined such that the cap material is removed revealing a surface of the block 108 beneath. However, the machining is performed so as to leave a lip 118. A top edge surface 606 of the block 108 is retained below a lip 118 circumscribing the pocket 106.

FIG. 13 is a partial view of a rotary tool with machined cavities filled with dough 1300.

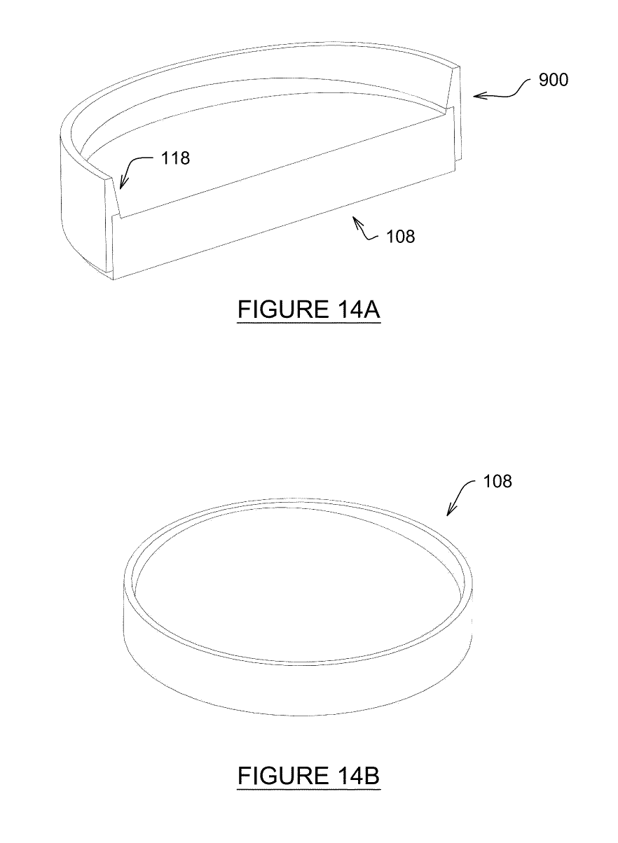

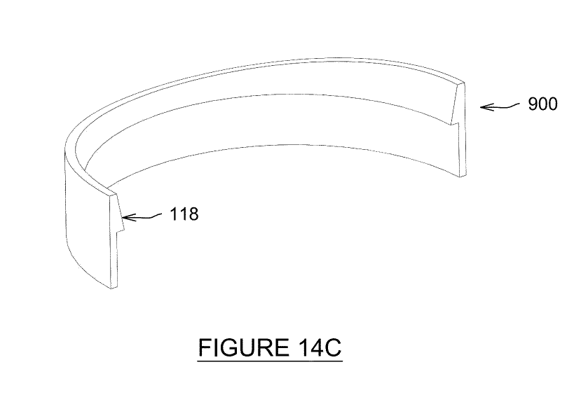

FIGS. 14A-C are views of the cavity insert removed from the pocket 106 after machining. These images demonstrate the tailoring of the cavity insert that is possible with this method. The rotary tool surface is arcuate or curved. The distance between the flat bottom of the mold cavity 600 and the curved surface of the rotary tool thus changes depending on where within the mold cavity 600 the distance is measured. FIG. 14A is a view of the cavity insert with the block 108 assembled with remaining portions of the cap 900, showing the lip 118. FIG. 14B shows block 108 (which has been machined) removed from the cap 900. FIG. 14C is a cross section of the machined cap 900 removed from the rotary tool and with the block 108 removed.

The advantages of the lip 118 are discussed in detail throughout this specification and are incorporated herein as equally applicable if the cap method is used to create the lip 118.

The method of removably assembling a block 108 with a rotary tool 104 includes the steps of:

(1) providing a tool, which may be a rotary tool or a plate mold tool;

(2) machining a pocket 106 into the surface of the tool;

(3) optionally, machining an interference structure 302 into the side walls of the cavity;

(4) providing a cavity insert, the cavity insert including the assembly of a cap 900 with a block 108;

(5) optionally, cooling the cavity insert, e.g., treating the cavity insert with liquid nitrogen to create a liquid nitrogen treated cavity insert (e.g., a cavity insert which has decreased in size due to liquid nitrogen treatment);

(6) inserting the cavity insert, which may be a liquid nitrogen treated cavity insert, into the pocket 106;

(7) allowing the cavity insert to obtain a temperature, e.g., room temperature, the temperature of the tool or otherwise; (which will cause the cavity insert to increase in size);

(8) machining the top surface of the cap 900 portion of the cavity insert, e.g., resulting in a cap top surface 902 that is continuous with the tool outer surface 128; and

(9) machining a mold cavity 600 into the cavity insert; the mold cavity 600 machined to a depth below the surface of the tool representing, e.g., the desired depth of the product to be molded; the mold cavity 600 alternatively or additionally having a desired shape, thickness, and imprinted design; and the mold cavity 600 circumscribed by a lip 118.

It should be understood that the interference structures 302 and/or interruption sections 304 may be applied to any of the following regions: and inner surface of the pocket 106 (e.g., walls or floor), an outer surface of the block 108 (e.g., top, sides, or bottom), an outer surface of the cap 900 (e.g., sides or top), an inner surface of the cap 900 (e.g., roof or side walls).

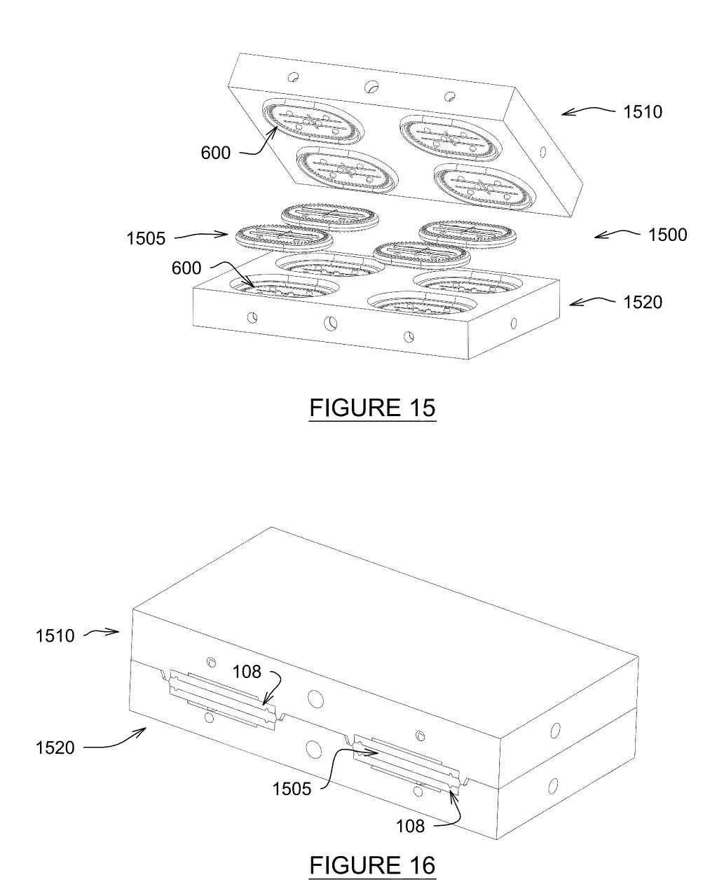

FIG. 15 through FIG. 18 demonstrate application of the invention to a plate mold 1500. A three dimensional consumable 1505 may be shaped by a mold structure. A mold structure may include a first plate 1510 and a second plate 1520. The first plate 1510 and/or second plate 1520 may be constructed of, for example but not limited to, aluminum, steel, copper, or other suitable metal or non metal material. In a variation, the first plate 1510 and/or second plate 1520 may be constructed entirely or partially of a porous material.

Each of the first plate 1510 and the second plate 1520 may have at least one mold cavity 600. The mold cavity 600 may be applied to the first plate 1510 and/or second plate 1520 by, e.g., etching, milling, EDM (electrical discharge machining), molding, or engraving processes.

The mold cavity 600 of the first plate 1510 may align with the mold cavity 600 of the second plate 1520. During use, a mass of a dough material is placed into an open mold cavity 600 of the first plate 1510 and/or the second plate 1520. The dough material may be temperature optimized for compression. The first plate 1510 and the second plate 1520 are placed into a closed formation. The closed formation aligns the mold cavity 600 of the first plate 1510 with the mold cavity 600 of the second plate 1520 such that mass of dough material is formed into a shape matching the contour of the aligned mold cavities. (A dough material is a term that refers to the pre-cooked/pre-dried/pre-hardened/pre-solidified format of the ultimate consumable 1505). The mold is opened and the resulting three dimensional consumable may drop freely from the mold.

The mold structure may have a single cavity or may have as many cavities as is practical. FIG. 15 illustrates a four-cavity mold for convenience and ease of illustration. While the first plate 1510 and/or second plate 1520 are shown with complementary cavities capable of creating 3-D products, it should be understood that the disclosed technology can be applied to a single plate construction (e.g., which may be filled with product dough and then scraped) or a construction in which either the first plate 1510 or the second plate 1520 are flat and therefore create a product with a contoured side and a flat side.

FIG. 16 demonstrates a cross section of the first plate 1510 and the second plate 1520 in a closed conformation. In cross section, one can see that the mold cavity 600 may be machined into a block 108 which is inserted into a pocket 106 in first plate 1510 and/or second plate 1520. A plate mold may thereby benefit from the methods described herein for using a pocket 106 and block 108 assembly to extend the life and fidelity of a mold cavity 600.

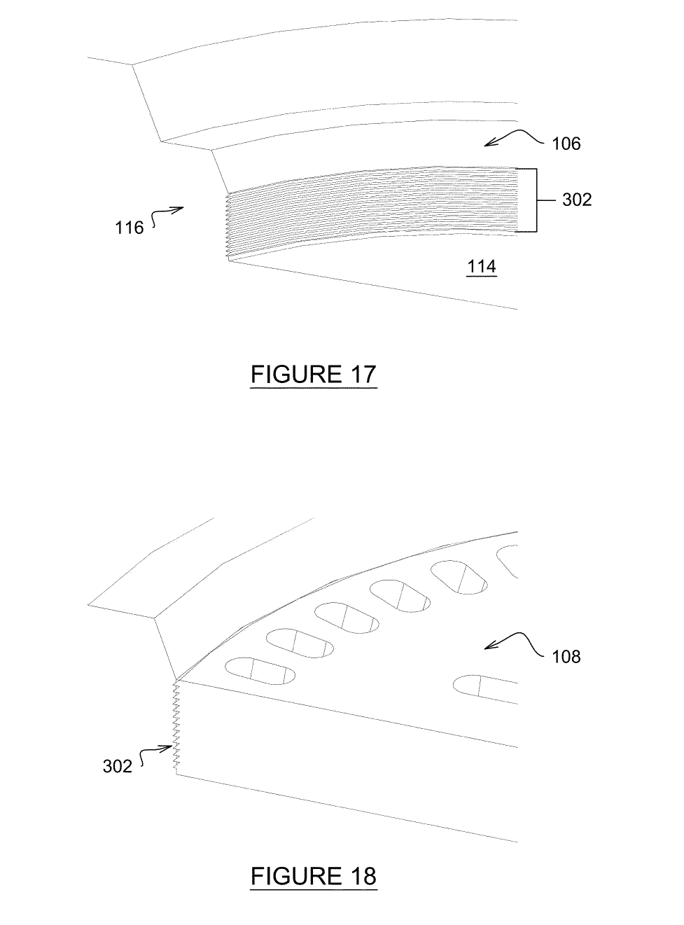

For example, a pocket 106 may be machined into the surface of a first plate 1510 and/or a second plate 1520 as shown in FIG. 17. The pocket 106 may have a bottom wall 114 and a pocket sidewall 116. The inner surface of the pocket, e.g., the pocket sidewall 116 or otherwise, may include an interference structure 302, for example but not limited to serrations. In this variation, the interference structure 302 is illustrated as a set of horizontal serrations. In a variation, the serrations of the interference structure 302 may be, for example but not limited to, approximately 0.001 inch to approximately 0.015 inch (or any value in between) from tip of serration to surface of a pocket sidewall 116. It should be understood that the serrations may have various orientations and fall within the scope of the definition. The interference structure 302 may refer to any set of structures machined into the pocket sidewall 116.

As discussed herein, the block 108 may be liquid nitrogen treated, reducing the block 108 size. The block 108, may be inserted into the pocket 106 in a reduced state. As the block warms it may expand. Expansion of the block 108 may cause the block 108 to swell in the pocket 106 pushing firmly into the sidewalls of the pocket 106, creating a compression fit. This may allow an interference structure 302 to bite deeply into the sidewalls of the pocket 106. The mold cavity 600 may be machined into the block 108 after it is fit and retained in the pocket 106. The mold cavity 600 may be machined or molded in the block 108 prior to fitting it into the mold cavity.

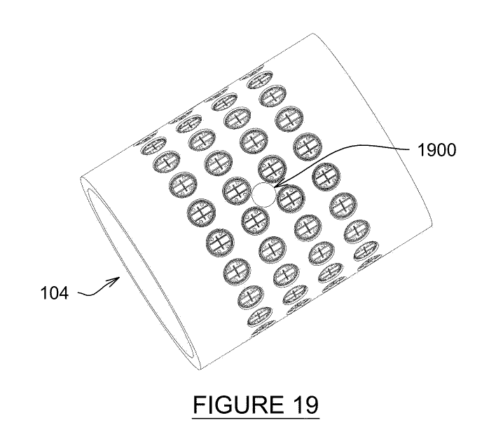

FIGS. 19 through 23 provide a further illustration of the use of the combination of a pocket 106 and a block 108 assembled using liquid nitrogen technology.

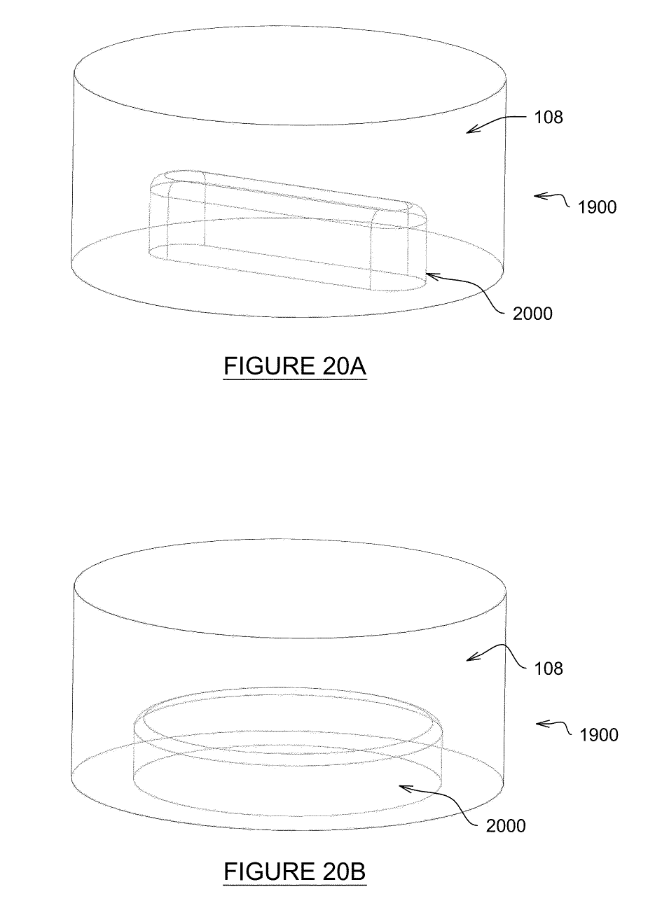

FIG. 19 provides a tool, which may be a rotary tool 104. In this variation, the rotary tool 104 includes an electronic insert 1900. An electronic insert 1900 is a general term referencing an insert which is assembled with or otherwise delivers an electronic device (FIG. 20, 2000 to a tool.) While the electronic insert 1900 is shown inserted onto an outer surface of the tool, it should be understood that the electronics insert 1900 may be inserted on any surface of the tool, including sides or inner surfaces. However, it is shown on an outer surface for ease of illustration.

FIGS. 20A and 20B provide an isolated view of an electronic insert 1900. An electronic insert 1900 may include a block 108 and an electronic device 2000. The block 108 may be made of any material known in the art of manufacturing rotary tool inserts, (including but not limited to acetyl). The block 108 may be assembled with an electronic device 2000. The electronic device 2000 may be, for example but not limited to, any one or a combination of an RFID, an NFC, a device that emits signal, a device that receives signal, a device that stores information, a device that transmits information, a device that has magnetic or other properties that can be read or detected by an electronic device, or any other device that has, controls, or directs an electric current. In FIGS. 20A and 20B the electronic device 2000 is illustrated in a disk shape and a capsule shape, respectively. However, these shapes are provided only for illustration.

A method of inserting an electronic device 2000 into a molding tool, such as but not limited to a rotary tool 104 or a mold plate tool, may include the following steps. Not all of the steps are required, more steps may be added, and the steps may be performed in a different order and/or by different entities.

(1) providing a molding tool, which may be a rotary tool or a plate mold tool;

(2) machining a pocket 106 into a surface of the tool;

(3) optionally, machining an interference structure 302 into the side walls of the cavity;

(4) providing a cavity insert, the cavity insert sized larger than the pocket 106, and the cavity insert including the assembly of an electronic device 2000 with a block 108;

(5) cooling the cavity insert, e.g., treating the cavity insert with liquid nitrogen to create a liquid nitrogen treated cavity insert (e.g., a cavity insert which has decreased in size due to liquid nitrogen treatment);

(6) inserting the cavity insert, which may be a liquid nitrogen treated cavity insert, into the pocket 106;

(7) allowing the cavity insert to obtain a temperature, e.g., room temperature, the temperature of the tool or otherwise; (which will cause the cavity insert to increase in size); and

(8) optionally machining the top surface of the block 108 portion of the cavity insert such that it is continuous with the tool outer surface 128.

As discussed previously, a pocket 106 may be machined into the surface of a tool. A rotary tool is demonstrated in FIG. 19, however, prior figures demonstrate how the same method may be applied to a mold plate tool.

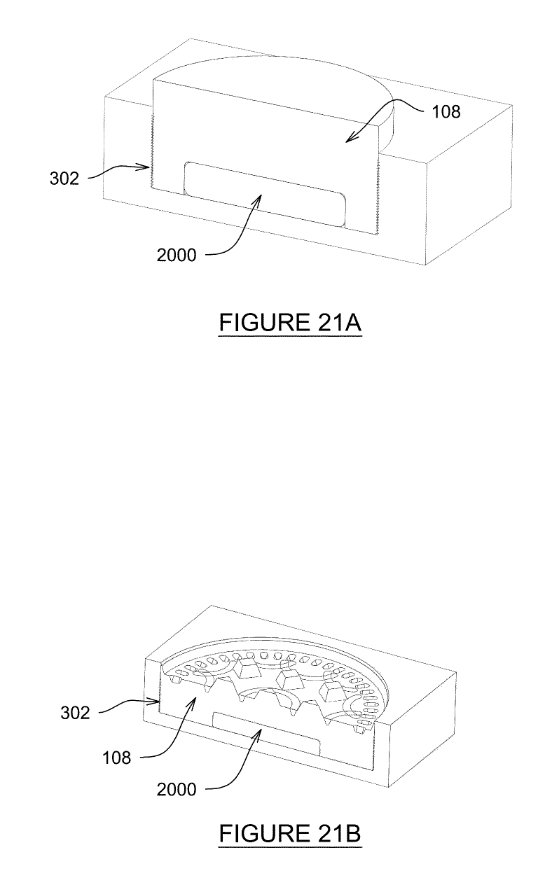

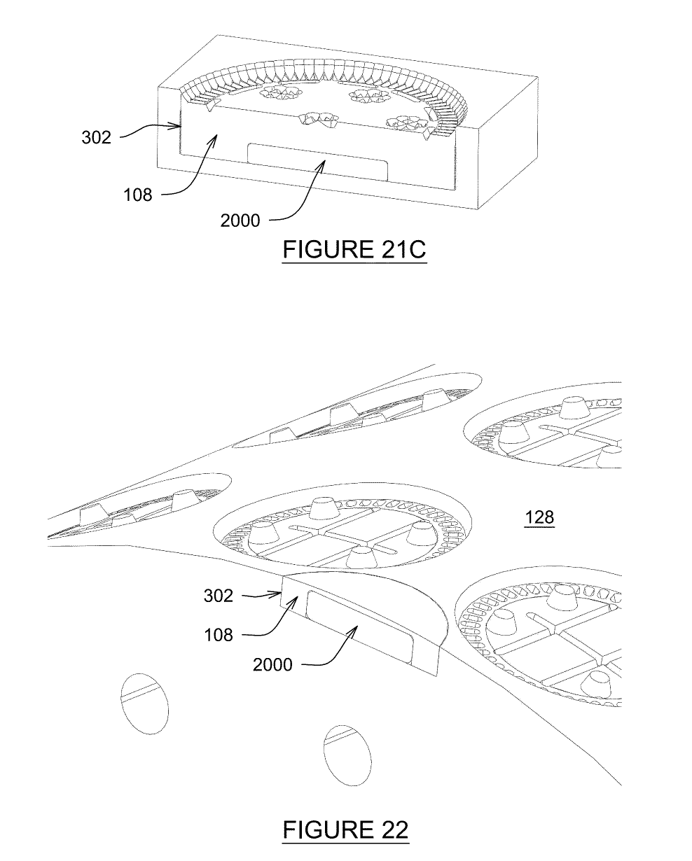

FIG. 21A provides an isolated cross section view of the block 108 assembled with an electronic device 2000 seated in a pocket 106. The pocket 106 may have an inner surface, which may include a bottom wall 114 and a pocket sidewall 116. The inner surface may include an interference structure 302, for example but not limited to serrations. In this variation, the interference structure 302 is illustrated as a set of horizontal serrations. In a variation, the serrations of the interference structure 302 may be of various orientations and fall within the scope of the definition. The interference structure 302 may refer to any set of structures machined into the pocket sidewall 116.

As the block 108 warms it may expand. Expansion of the block 108 may cause the block 108 to swell in the pocket 106 pushing firmly into the sidewalls of the pocket 106, creating a compression fit. This may allow the interference structure 302 to bite deeply into the sidewalls of the block 108.

FIG. 21B provides an isolated cross section view of the variation of FIG. 7A assembled with an electronic device 2000. Here it is demonstrated that an electronic device 2000 may be integrated into a rotary tool at various locations, e.g., integrated into a block 108 comprising a mold cavity 600.

FIG. 21C provides an isolated cross section view of the variation of FIG. 8A assembled with an electronic device 2000. Here it is demonstrated that an electronic device 2000 may be integrated into a rotary tool at various locations, e.g., integrated into a block 108 comprising a mold cavity 600.

FIG. 22 provides a cross section of a region of a tool in which an electronic device has been embedded. Here, the block 108 has been machined to be flush with the surface of the tool. Of course, depending on the location of the block 108, the machining step may not be necessary. The machining step may only be necessary where a smooth, uninterrupted surface is desired. Furthermore, depending on the location, the block 108 may be below the surface into which it is embedded.

The disclosed method has several advantages over conventional methods. The method improves the machining of the blocks 108 because there are fewer features to machine into the block 108 prior to insertion, e.g., removes necessity of accommodating the male-female groove. Block insertion may be permanent, the interference structures “bite” into the block, removing the requirement for adhesives (e.g., epoxy) or other securing devices. The method also removes the current requirement of a vent hole at the bottom of the pocket 106. The tight fit achieved by the method makes it impervious to water or foodstuff entering between the block 108 and the pocket 106. For example, under the conventional method, epoxy cracks leaving a space. Water or food stuff enters the space and swells the block, causing a crevice to open up and perhaps causing the block to buckle. The opening of a crevice may create product defects due to, e.g., loss of retention fit, deformation of the mold surface, and otherwise as disclosed herein.

Assembly time is reduced because the method removes the need for waiting for the adhesives to harden.

While variations of the invention have been described, it will be apparent to those of skill in the art that many more implementations are possible that are within the scope of the claims.

1. A method of retaining a block in a pocket of a molding tool, the method comprising the steps of:
a. providing a tool, the tool comprising a pocket arranged on a surface of the tool for receiving an insert;
b. providing the insert, the insert having a size slightly larger than that of the pocket;
c. cooling the insert prior to installation;
d. installing the insert into the pocket; and
e. wherein the insert is secured to the pocket with a compression fit.

2. The method of claim 1, wherein cooling the insert comprises treating the insert with liquid nitrogen.

3. The method of claim 1, where the insert comprises a block.

4. The method of claim 1, where the insert comprises a block assembled within a cap.

5. The method of claim 1, further comprising the step of:
a. machining an interference structure into an inner surface of the pocket.

6. The method of claim 1, further comprising the step of:
a. providing a lip circumscribing the pocket, the lip having a diameter that is smaller than that of the pocket.

7. The method of claim 1, further comprising the steps of:
a. machining a mold cavity into the insert.

8. The method of claim 1, the insert comprising an interference structure on an outer perimeter to secure it in place with respect to the pocket.

9. The method of claim 1, where the tool is a rotary tool or a plate mold tool.

10. A mold, the mold comprising:
a. a pocket, the pocket comprising an opening;
b. an insert positioned within the pocket;
c. the insert secured within the pocket through a compression fit; and
d. the insert comprising a mold cavity.

11. The mold of claim 10, further comprising:
a. the pocket comprising a lip circumscribing an opening of the pocket;
b. the insert comprising a block;
c. the block positioned in the pocket and below the lip.

12. The mold of claim 10, further comprising:
a. the insert comprising a block;
b. the pocket comprising an inner surface, the inner surface comprising an interference structure capable of biting into an outer perimeter of the block.

13. The mold of claim 11, further comprising:
a. the pocket comprising an inner surface, the inner surface comprising an interference structure capable of biting into an outer perimeter of the block.

14. The mold of claim 12, the inner surface further comprising an interruption section.

15. The mold of claim 10, the insert further comprising a block assembled with an electronic device.

16. A method of installing an electronic device onto a surface of a molding tool, the method comprising the steps of:
a. providing a molding tool, the molding tool comprising a pocket arranged on a surface of the molding tool;
b. providing an insert, wherein
i. the insert is assembled with an electronic device;
ii. the insert is sized slightly larger than the pocket;
c. cooling the insert prior to installation; and
d. installing the insert into the pocket.

17. The method of claim 16, wherein cooling the insert comprises treating the insert with liquid nitrogen.

18. The method of claim 16, further comprising the steps of:
a. machining an interference structure into an inner surface of the pocket.

19. The method of claim 16, wherein the electronic device is an RFID device.

20. The method of claim 16, further comprising the step of:
a. embedding an interference structure on an outer perimeter of the insert.
